(19) United States
(12) Patent Application Publication
(10) Pub. No.: US 2001/0019090 A1
(43) Pub. Date: Sep. 6, 2001

(54) High pressure spray system

(76) Inventor: Arie Horev, Ramat Gan (IL)

Correspondence Address: Ladas & Parry, 26 West 61st Street, New York, NY, 10023, US

(21) Appl. No.: 09/741,745

(22) Filed: Dec. 19, 2000

(30) Foreign Application Priority Data
Dec. 19, 1999 (IL) 133594

(51) Int. Cl. B64D 1/00

(52) U.S. Cl. 244/136

(57) ABSTRACT

This invention discloses a high pressure spray system including an aircraft, a high pressure pump including a rotatable shaft, mounted on the aircraft, a propeller connected to the shaft and a spray boom mounted on the aircraft and in fluid communication with the high pressure pump, wherein rotation of the propeller during flight of the aircraft increases rotation of the shaft and increases a pressure output of the pump.

### FIELD OF THE INVENTION

The present invention relates generally to high pressure spray systems for aircraft and particularly to such a system for spraying certain kinds of salt solutions for seeding clouds.

### BACKGROUND OF THE INVENTION

It is well known that clouds can be “seeded” with certain kinds of salt solutions, such as a silver iodide water solution, that increase rainfall. Generally the cloud is seeded by means of an aircraft that carries specially designed equipment that produce a steam spray of the salt solution. The aircraft flies just before or during rainfall underneath the clouds and emits a spray, generally of 5 νm size droplets, which is sucked into the bottom of the clouds. The absorbed salt solution then increases the rainfall.

Besides the disadvantage of the equipment being expensive and relatively heavy, there is another serious drawback to the above described method. Because the flight must be made in the midst of the clouds themselves, just before or during rainfall that can be accompanied by lighting strikes, there is a serious danger to the pilot. Indeed pilots have lost their lives seeding clouds with the prior art methods.

### SUMMARY OF THE INVENTION

The present invention seeks to provide a novel high pressure spray system, externally mounted on an aircraft, that enables seeding clouds safely. The aircraft seeds the clouds during flight underneath and outside of the clouds, which is significantly safer than the prior art. The system can be installed on crop duster aircraft, and is relatively simple and inexpensive in construction. The system of the present invention has successfully seeded cumulus clouds in tests performed in safe, non-rainy flight conditions, using a crop duster, SNOW COMMANDER Model 600 S-2D. However, the system of the invention can be mounted on any other aircraft as well.

It should be noted that heretofore crop duster aircraft have been inadequate for cloud seeding because the pressure and droplet sizes associated with crop dusting piping and equipment have been unsuitable for cloud seeding. Crop dusting materials are not rich in salts and are typically dispensed at relatively low pressures, such as 4 bar. It has been heretofore impossible to spray 5 μm size droplets of salt solutions with crop duster equipment, because such solutions typically require pressures exceeding 70 bar

The high pressure spray system of the present invention solves this problem by means of a variable pitch propeller, preferably installed on the underside of the aircraft which is connected to a shaft of a high pressure pump. The rotation of the propeller during flight greatly increases the pump shaft rotation and thereby increases the pressure output of the pump. In this manner, the pump can easily reach pressures of 75 bar and more, and can easily pump salt water solution in the required 5 μm size droplets at a rate of 1000 liters per hour. A pressure relief valve and RPM gauge are preferably installed to control and limit the pressure and rotation of the pump. The pitch of the variable pitch propeller is preferably controlled by the pilot via a control cable.

There is thus provided in accordance with a preferred embodiment of the present invention a high pressure spray system including an aircraft, a high pressure pump including a rotatable shaft, mounted on the aircraft, a propeller connected to the shaft, and a spray boom mounted on the aircraft and in fluid communication with the high pressure pump, wherein rotation of the propeller during flight of the aircraft increases rotation of the shaft and increases a pressure output of the pump. A fluid, such as AgI solution, is pumped by the pump to the spray boon, the fluid exiting the spray boom as a steam spray. Preferably the propeller is mounted on an underside of the aircraft.

In accordance with a preferred embodiment of the present invention the propeller includes a variable pitch propeller. Preferably a control cable is connected to the propeller for controlling a pitch of the propeller.

Further in accordance with a preferred embodiment of the present invention a spray valve is in fluid communication with the pump and the spray boom.

Still further in accordance with a preferred embodiment of the present invention a pressure relief valve is in fluid communication with the pump.

Additionally in accordance with a preferred embodiment of the present invention a cockpit-mounted pressure gauge is in fluid communication with the pump.

In accordance with a preferred embodiment of the present invention a cockpit-mounted tachometer is connected to the pump for measuring and displaying rotation of the pump.

### BRIEF DESCRIPTION OF THE DRAWINGS

The present invention will be understood and appreciated more fully from the following detailed description, taken in conjunction with the drawings in which:

FIG. 1 is a simplified pictorial illustration of a high pressure spray system, constructed and operative in accordance with a preferred embodiment of the present invention;

FIG. 2 is a simplified pictorial illustration of the main components of the high pressure spray system of FIG. 1; and

FIG. 3 is a simplified pictorial illustration of a cockpit-mounted pressure gauge and a tachometer useful in high pressure spray system of FIG. 1.

### DETAILED DESCRIPTION OF A PREFERRED EMBODIMENT

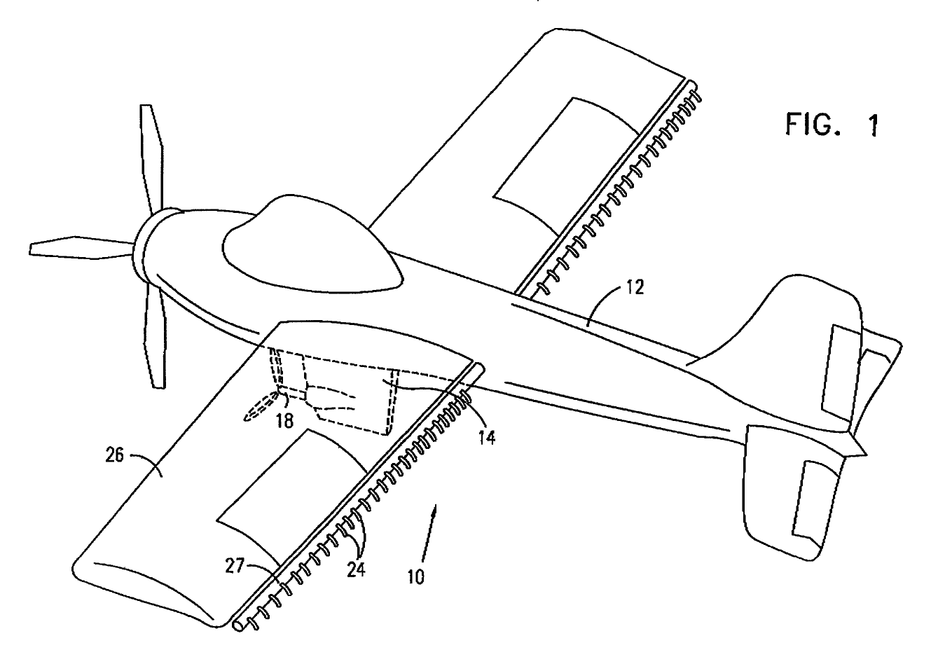

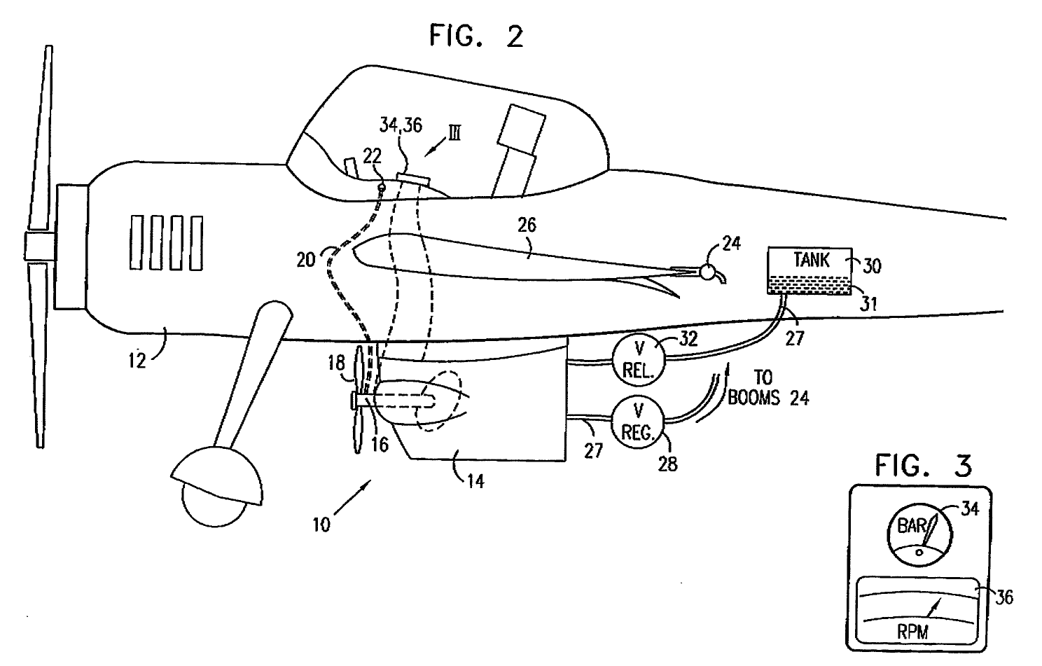

Reference is now made to FIGS. 1 and which illustrate a high pressure spray system 10, constructed and operative in accordance with a preferred embodiment of the present invention. The system 10 is illustrated on an aircraft 12, such as a crop duster, SNOW COMMANDER Model 600 S-2D, on which successful trials of the invention have been performed.

A high pressure pump 14 including a rotatable shaft 16 is preferably mounted on an underside of aircraft 12. A example of a suitable pump is KRANZLE 205T, with a maximum pressure rating of pb 205 bar. The KRANZLE pump, which is a so-called inclined plate type of pump, is preferably slightly modified such that shaft 16 is readily accessible for attachment to a propeller 18, such modification being readily performed by a skilled person of the art.

Propeller 18 is connected to shaft 16 by means of any suitable coupling. Propeller 18 is preferably a variable pitch propeller and is connected to a control cable 20 which permits a pilot (not shown) to control the pitch of the propeller 18, such as by means of a handle 22 mounted on a cockpit-end of cable 20. An example of a suitable propeller and control cable is the F100A COCKPIT CONTROLLABLE WINDMILL, made by WEATH-AERO.

One or more spray booms 24 are preferably mounted on wings 26 of aircraft 12 and are in fluid communication with pump 14. Booms 24 are preferably installed in the same manner as standard crop dusting booms, such as on the trailing edge of each wing 26. The nozzle tips of the booms 24 may be oriented downwards as in normal crop dusting. Alternatively, the nozzle tips may be turned generally perpendicularly to the air stream. This orientation is advantageous because the air stream tends to break up the droplets into smaller droplets, thereby producing a fine mist.

High pressure tubing and fittings, generally designated by reference numeral 27, such as STRATOFLEX from AAR COOPER, are preferably used to connect pump 14 to booms 24. A spray valve 28 is preferably in fluid communication with pump 14 and booms 24. Spray valve 28 may be a 250 bar ball valve controlled by the pilot by means of an existing mechanical push-pull rod system (not shown).

A liquid tank 30 is preferably in fluid communication with pump 14 by means of the high pressure tubing and fittings 27. Tank 30 contains a fluid 31, such as AgI solution, which pump 14 pumps to spray booms 24, fluid 31 exiting spray booms 24 as a spray. A pressure relief valve 32 is preferably in fluid communication with pump 14 and is installed near tank 30. Pressure relief valve 32 ensures that no over pressure of pump 14 will occur.

A cockpit-mounted pressure gauge 34 is preferably in fluid communication with pump 14 to provide pressure readings thereof. A cockpit-mounted tachometer 36 is preferably connected to pump 14 for measuring and displaying rotation thereof.

During flight of aircraft 12, rotation of propeller 18 increases rotation of shaft 16 and increases a pressure output of pump 14. In flight tests performed, it was shown that pump 14 can easily reach pressures of 75 bar and more, and can easily pump AgI solution in the required 5 μm size droplets at a rate of 1000 liters per hour. Thus the present invention enables safe cloud seeding with a crop duster.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. A high pressure spray system comprising:
an aircraft;
a high pressure pump including a rotatable shaft, mounted on said aircraft;
a propeller connected to said shaft; and
a spray boom mounted on said aircraft and in fluid communication with said high pressure pump, wherein rotation of said propeller during flight of said aircraft increases rotation of said shaft and increases a pressure output of said pump.

2. The system according to claim 1 wherein said propeller comprises a variable pitch propeller.

3. The system according to claim 2 and further comprising a control cable connected to said propeller for controlling a pitch of said propeller.

4. The system according to claim 1 and further including a spray valve in fluid communication with said pump and said spray boom.

5. The system according to claim 1 and further including a pressure relief valve in fluid communication with said pump.

6. The system according to claim 1 and further including a fluid pumped by said pump to said spray boom, said fluid exiting said spray boom as a spray.

7. The system according to claim 1 and further including a cockpit-mounted pressure gauge in fluid communication with said pump.

8. The system according to claim 1 and further including a cockpit-mounted tachometer connected to said pump for measuring and displaying rotation of said pump.
